(19) United States
(12) Patent Application Publication
(10) Pub. No.: US 2004/0213952 A1
(43) Pub. Date: Oct. 28, 2004

(54) Fiber reinforced plastic structural member

(75) Inventors: Shinichi Takemura, Yokohama-shi (JP); Hideyuki Komaki, Yokohama-shi (JP); Akio Sakamoto, Tokyo (JP); Yutaka Sanokawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NIPPON OIL CORPORATION, Tokyo (JP)

(21) Appl. No.: 10/625,694

(22) Filed: Jul. 24, 2003

(30) Foreign Application Priority Data
Jul. 31, 2002 (JP) 2002-224241

(51) Int. Cl. B32B 5/12

(52) U.S. Cl. 428/105; 428/113

(57) ABSTRACT

This invention relates to an FRP structural member comprising reinforcing fibers, which comprises carbon fibers (a) having tensile modulus of 400 to 850 GPa, in which the carbon fibers (a) are placed so that the orientation direction of the carbon fibers (a) becomes parallel to the longitudinal direction of the structural member. The FRP structural member has high vibration-damping property and much lower production cost as well as light weight, high rigidity and superior corrosion property.

### BACKGROUND OF THE INVENTION

1. Technical Field

This invention relates to a fiber reinforced plastic (FRP) structural member comprising carbon fibers Such FRP structural member is used as various shapes of general structures, building structures and constructions, for example, reinforcing materials, aggregates, frame materials, beams, columns, supporting legs, rails, guides, sash bars, wall materials, girders and the like.

2. Description of the Prior Art

For conventional FRP structural members, reinforcing fibers having relatively low modulus, such as glass fibers, aramid fibers and the like, have been used, or alternatively, as described in JP-A1-9203159, carbon fibers having tensile modulus of 180 to 300 GPa have been used. Therefore, the conventional structural member was often deteriorated in bending rigidity. Furthermore, there has been a problem that, in order to exhibit practical bending rigidity, the thickness of the member must be increased, but which leads to the increase of the weight of the member and increase of costs of materials and of production. Therefore, the conventional FRP structural member has not been lower than conventional steel structural members in costs. Alternatively, there has been a method for improving the moment of inertia of area by increasing the height (in the direction of the cross-section) of the member (beam) in order to improve bending rigidity. However, such method requires larger metal molds used for producing said member, which leads to the increase of the production cost.

Furthermore, in view of use for bridges, architectures and the like, it is an important object to provide high vibration-damping property for structural members in order to suppress vibration of the whole building structures. However, no structural members having superior vibration-damping property have been known yet.

### SUMMARY OF THE INVENTION

An object of this invention is to solve the above-mentioned problems. This invention aims at providing an FRP structural member, which has higher vibration-damping properties and much lower production cost than those of conventional members, as well as which has light weight, high rigidity and superior corrosion property.

Namely, this invention relates to an FRP structural member comprising reinforcing fibers, which comprises carbon fibers (a) having tensile modulus of 400 to 850 GPa, in which the carbon fibers (a) are placed so that the orientation direction of the carbon fibers (a) becomes parallel to the longitudinal direction of the structural member.

Said FRP structural member may further comprises carbon fibers (b) having tensile modulus of 200 to less than 400 GPa, in which the carbon fibers (b) are placed so that the orientation direction of the carbon fibers (b) becomes parallel to the longitudinal direction of the structural member.

Said carbon fibers (a) may be placed in the range of not more than 50% of the distance between the surface of the member and a neutral surface in the cross-section surface of the member and in the direction of the neutral surface from the surface of the member. Said carbon fibers (b) may be placed in the range of not more than 50% of the distance between the surface of the member and a neutral surface in the cross-section surface of the member and in the direction of the neutral surface from the surface of the member.

Said FRP structural member may further comprises carbon fibers (c) having tensile modulus of 200 to 850 GPa, in which the carbon fibers (c) are placed in the site vertical to the neutral surface in the cross-sectional surface of the member and wherein the orientation direction of the carbon fibers (c) forms an angle of ±45 degrees relative to the longitudinal direction of the member.

In said FRP structural member, a total amount of the carbon fibers (a), the carbon fibers (b) and the carbon fibers (c) used may be 5 to 25% by mass, based on a total amount of the reinforcing fibers and carbon fibers used in the FRP structural member.

### BRIEF DESCRIPTION OF THE DRAWINGS

FIG. 1 shows a cross-sectional view of the member having an I-shaped cross-section.

FIG. 2 shows a cross-sectional view of the members each having H-shaped, C-shaped and L-shaped cross-sections.

FIG. 3 shows a cross-sectional view of the members each having I-shaped, H-shaped, C-shaped and L-shaped cross-sections.

FIG. 4 shows a schematic view of cantilever method for measuring vibration-damping property.

FIG. 5 shows a free vibration wave profile.

FIG. 6 shows laminate structures of the unidirectional prepregs of Examples 1 and 2.

FIG. 7 shows a laminate structure of the unidirectional prepreg of Example 3.

FIG. 8 shows a laminate structure of the unidirectional prepreg of Example 4.

FIG. 9 shows comparison of production costs for various kinds of I-shaped beams.

FIG. 10 shows a laminate structure of the unidirectional prepreg of Comparative Example 1.

FIG. 11 shows a laminate structure of the unidirectional prepreg of Comparative Example 2.

FIG. 12 shows a laminate structure of the unidirectional prepreg of Comparative Example 3.

In said figures, number 1 denotes a flange, number 2 a web, number 3 a neutral surface, number 4 a one-end anchoring device, number 5 a strain gauge, number 6 a bridge box, number 7 an amplifier, number 8 a unidirectional FRP sample piece, number 9 a computer, number 10 a glass fiber unidirectional prepreg wherein fibers are oriented at an angle of +45 degrees, number 11 a glass fiber unidirectional prepreg wherein fibers are oriented at an angle of −45 degrees, number 12 a glass fiber unidirectional prepreg wherein fibers are oriented at an angle of 90 degrees, number 13 a carbon fiber T700S unidirectional prepreg wherein fibers are oriented at an angle of 0 degree, number 14 a carbon fiber XN-80 unidirectional prepreg wherein fibers are oriented at an angle of 0 degree, number 15 a glass fiber unidirectional prepreg wherein fibers are oriented at an angle of 0 degree, number 16 a carbon fiber XN-80 unidirectional prepreg wherein fibers are oriented at an angle of +45 degrees, and number 17 a carbon fiber XN-80 unidirectional prepreg wherein fibers are oriented at an angle of −45 degrees.

### DESCRIPTION OF THE PREFERRED EMBODIMENTS

Hereinafter the desirable embodiments for the FRP structural member of this invention are exemplified.

(Materials)

The term “reinforcing fibers” as referred in this invention means reinforcing fibers other than carbon fibers. Such fibers generally include glass fibers, aramid fibers, polyethylene fibers or mixed fibers thereof. Those fibers can be used for the FRP structural member of this invention.

Among these reinforcing fibers, large amounts of glass fibers and aramid fibers are preferably used in large-scale members and the like because they require low costs. Furthermore, by using the glass fibers and aramid fibers, FRP having superior corrosion resistant can be obtained, whereby sufficient durability for structures and the like can be provided and specific strength can be enhanced because of weight saving.

The reinforcing fibers generally have tensile modulus of 60 to 130 GPa, preferably 70 to 130 GPa, and tensile strength of 1500 to 4500 MPa, preferably 2500 to 4500 MPa, and can be used as short fibers or continuous fibers.

(Embodiments for Using Reinforcing Fibers)

When reinforcing fibers are used in the form of unidirectional prepregs, and fabrics such as plain woven fabrics, satin woven fabrics, cord woven fabrics and the like, the unidirectional prepregs and said fabrics can be formed by hand-lay-up method, autoclave forming method, RTM (resin transfer molding) method or RFI (resin film injection) method. When bobbins or fabrics are formed, a forming method that comprises drawing long-shaped materials such as a beam and the like, can be used.

When the orientation direction of the reinforcing fibers is oriented in parallel relative to the longitudinal direction of the FRP structural member of this invention, namely, oriented at an angle of zero degree, the bending rigidity of the member is improved. For example, for a beam having an I-shaped cross-section and a beam having an H-shaped cross-section, it is effective to orient the reinforcing fibers in parallel to the longitudinal direction of the member at flange sites (opposing surfaces). The term “longitudinal direction” herein means a direction vertical to the cross-sectional surface.

The reinforcing fibers oriented at angles of ±45 degrees relative to the longitudinal direction of the FRP structural member are mainly used in a site vertical to the neutral surface (such as a web of a beam having an I-shaped cross-section, a web of a beam having an H-shaped cross-section or the like, etc.), which can suppress the shear deformation of the member. When the reinforcing fibers are oriented at an angle of 90 degrees relative to the longitudinal direction of the FRP structural member of this invention in a site vertical to the neutral surface (such as a web of a beam having an I-shaped cross-section, a web of a beam having an H-shaped cross-section or the like, etc.), the compressive strength of the member can be improved. The “neutral surface” mentioned in this invention means a surface in the member, which does not extend and does not shrink when the member is bent.

The carbon fibers used for the FRP structural member of this invention can be classified in the carbon fibers (a), carbon fibers (b) and carbon fibers (c), depending on the site wherein the fibers are to be used and on the tensile modulus of the carbon fibers.

The total amount of the carbon fibers (a), carbon fibers (b) and carbon fibers (c) may be 5 to 25% by mass, preferably 5 to 20% by mass, based on the total amount of the reinforcing fibers and carbon fibers used in the FRP structural member.

The carbon fibers (a) may have tensile modulus of 400 to 850 GPa, preferably 500 to 850 GPa, more preferably 600 to 850 GPa, and tensile strength of 2000 to 5000 MPa, preferably 2500 to 5000 MPa.

The carbon fibers (a) are preferably placed so that their orientation direction becomes parallel to the longitudinal direction of the structural member (namely, placed so as to form an angle of zero degree) and are placed in the range of not more than 50% of the distance between the surface of the member and a neutral surface in the cross-section surface and in the direction of the neutral surface from the surface of the member.

The carbon fibers (b) may have tensile modulus of 200 to less than 400 GPa, preferably 300 to less than 400 GPa, more preferably 350 to less than 400 GPa, and tensile strength of 2500 to 6000 MPa, preferably 3500 to 6000 MPa.

The carbon fibers (b) are preferably placed so that their orientation direction becomes parallel to the longitudinal direction of the structural member (namely, placed so as to form an angle of zero degree) and are placed in the range of not more than 50% of the distance between the surface of the member and a neutral surface in the cross-section surface and in the direction of the neutral surface from the surface of the member.

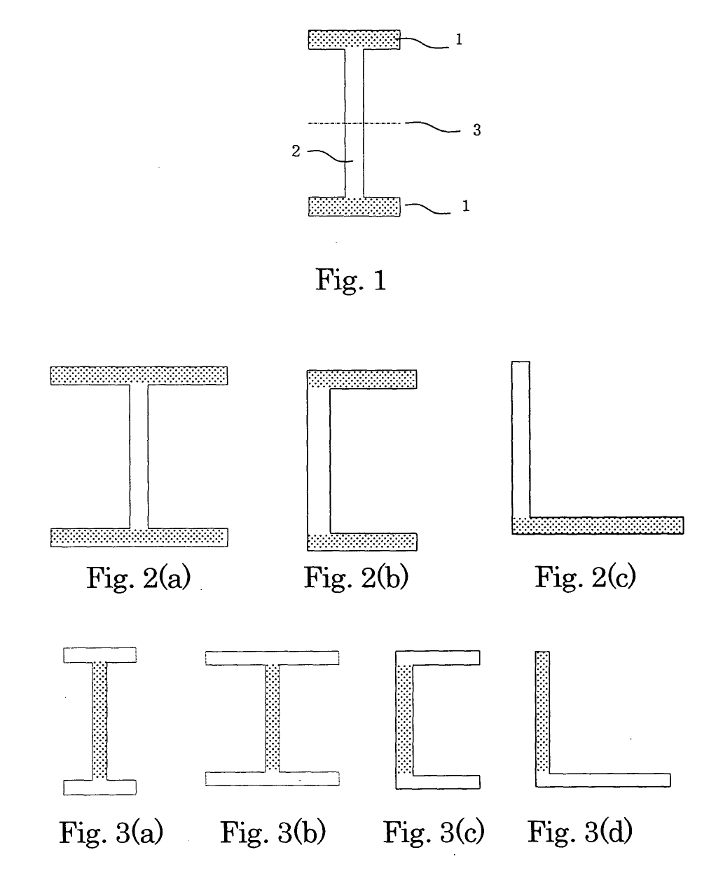

FIG. 1 shows the cross-section of a member having an I-shaped cross section. FIG. 1 shows examples of use of the carbon fibers (a) and carbon fibers (b), and these carbon fibers are placed in a surface parallel to the ground, such as flange sites 1 of the members having I-shaped and H-shaped cross-sections (hatching sites of FIG. 1), when the longitudinal surface of the FRP structural member is parallel to the ground, which effectively affects improvement of the bending rigidity of the member. More specifically, the neutral surface under bending deformation exists in the center of the height (cross-sectional direction) of the member, wherein the bending rigidity can be effectively improved by disposing carbon fibers having high modulus in the flange sites and the like apart from the neutral surface 3.

Each of the FIG. 2(a), FIG. 2(b) and FIG. 2(c) shows the cross-section of the member having an H-shaped, a C-shaped and an L-shaped cross-section, respectively. As shown in FIG. 2, it is effective for improvement of the bending rigidity to dispose carbon fibers having high modulus in the opposing flange sites of the member having a C-shaped cross-section, or in the lower flange site parallel to the ground of the member having an L-shaped cross-section (in each member, the carbon fibers are disposed in the hatched site).

The carbon fibers (c) may have tensile modulus of 200 to 850 GPa, preferably 500 to 850 GPa, more preferably 600 to 850 GPa, and tensile strength of 2000 to 5000 MPa, preferably 2500 to 5000 MPa.

In the FIG. 3(a), FIG. 3(b), FIG. 3(c) and FIG. 3(d) of, the cross-sections of the members having I-shaped, H-shaped, C-shaped and L-shaped cross-sections, respectively, are shown. The carbon fibers (c) are preferably disposed in the site vertical to the neutral surface in the cross-section of the member, such as a web 2 of the member having an I-shaped or an H-shaped cross-section and the like (the hatched site in FIG. 3) in which the orientation direction of said fibers is at angles of ±45 degrees relative to the longitudinal direction of the FRP structural member. The carbon fibers (c) can exhibit an effect for suppressing the bending deflection due to the shear deformation of the FRP structural member.

Especially, in the case of use of the FRP structural member for bridges, architectures and the like, it is important to provide high vibration-damping property for the FRP structural member in order to suppress the vibration of the whole bridge or the whole architecture.

The carbon fibers (a) and carbon fibers (c) used in this invention may be carbon fibers having high vibration-damping property, and pitch-based carbon fibers having high modulus are preferable.

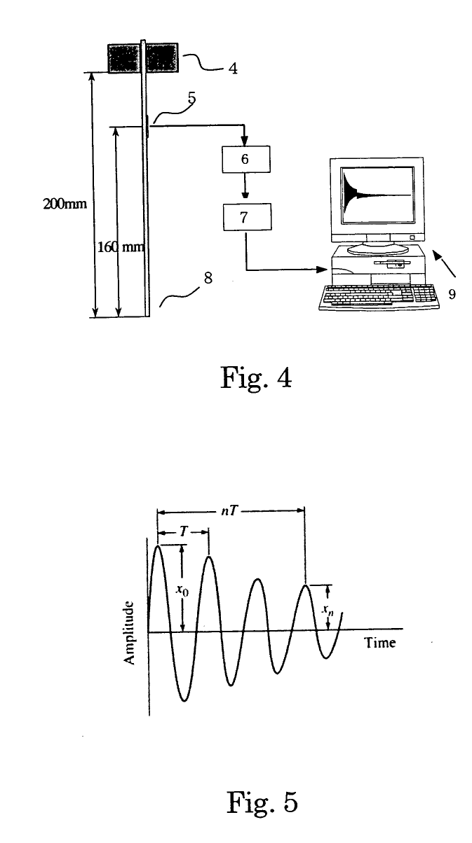

One example of a method for measurement of the vibration-damping property and the range of the logarithmic decrement effective for suppressing vibration is explained below. FIG. 4 shows a schematic view of cantilever method for measuring the vibration-damping property.

For the measurement of the vibration-damping property, a unidirectional FRP plate formed according to the following procedures was used. Reinforcing fibers were aligned unidirectionally, and then impregnated with an epoxy resin to prepare a reinforced fiber prepreg. This is referred to as a unidirectional prepreg. A prepreg having square shape (length in the direction of fibers of 300 mm×width of 300 mm) was cut out from the unidirectional prepreg. A predetermined number of the unidirectional prepregs cut out were laminated so that the orientation angles of the reinforcing fibers are the same as each other and that the thickness of a plate to be formed becomes 2 mm to give a laminate. The laminate was vacuum-pressure formed by an autoclave to give a unidirectional FRP plate having the length of 300 mm×width of 300 mm×thickness of 2 mm.

A strip sample piece, which has the length of 250 mm in the direction of the fibers×width of 10 mm, was cut out using a diamond cutter, and then used in the measurement of the vibration-damping property.

The above-mentioned sample piece 8 was fixed in the range from its end up to 50 mm to a one-end anchoring device 4 according to JIS-G0602 (Test methods for vibration damping property in laminated damping steel sheet) to prepare a cantilever comprising a free component having the length of 200 mm (FIG. 4).

A strain gauge 5 was adhered to the site apart from a free edge by 160 mm, and the strain gauge 5 and a bridge box 6 was connected. The bridge box 6 was connected to an amplifier 7 and the amplifier was connected to a computer 9. The strain of the unidirectional FRP sample piece 8 in the longitudinal direction was measured at the sampling interval of 500 μsec. A free vibration wave profile was obtained by vibrating the free end (FIG. 5). In FIG. 5, T denotes period, x amplitude and n the number of repetitive vibrations, respectively. Furthermore, according to the following equation, logarithmic decrement Δ was calculated.

$$Δ = \frac{1}{n} ln \frac{{x}_{0}}{{x}_{n}}$$

For this invention, the carbon fibers used as the carbon fibers (a) and the carbon fibers (c) preferably have the logarithmic decrement of not less than 0.015 and not more than 0.022 when the strain in the longitudinal direction of the member is 50 to 100 με, or the logarithmic decrement of not less than 0.017 and not more than 0.027 when the strain in the longitudinal direction of the member is 100 to 200 με, or the logarithmic decrement of not less than 0.020 and not more than 0.030 when the strain in the longitudinal direction of the member is 200 to 300 με, as well as tensile modulus of 400 to 850 GPa, preferably 500 to 850 GPa, more preferably 600 to 850 GPa, and the tensile strength of 2000 to 5000 MPa, preferably 2500 to 5000 MPa.

As this invention, by using the carbon fibers having high tensile modulus in the FRP structural member, the carbon fibers can act to enhance the strength and rigidity of the member by bearing the load applied on the member, and save the weight of the member, and can suppress the creep deformation of the member, enhance the joint efficiency of the bolting, enhance hostile-environment (acid resistance, solvent resistance) and can improve fatigue characteristics.

A matrix resin to be used for the FRP structural member of this invention includes both a thermosetting resin and a thermoplastic resin. The thermosetting resin includes an epoxy resin, an unsaturated polyester resin, a vinyl ester resin, a phenol resin and mixtures of two or more of them. The thermoplastic resin includes PEEK, a polyamide resin, a polycarbonate resin, an ABS resin and mixtures of two or more of them.

The shape of the cross-section of the FRP structural member of this invention may be I-shape as shown in FIG. 1, or H-shape, C-shape and L-shape as shown in FIG. 2, or alternatively, may be Z-shape, U-shape, T-shape, box-shape or flat shape, although which are not shown in the drawings.

Furthermore, when the bending deflection due to the shear deformation of the FRP structural member is to be suppressed using the above-mentioned carbon fibers (c), it is effective to use the carbon fibers (c) in the site vertical to the neutral surface in the beam cross-section each having I-shape, H-shape, C-shape and L-shape, as shown in FIG. 3.

(Method for Forming)

A method for preparing the FRP structural member of this invention includes any of the known forming methods such as pultrusion method, pull-wind forming method, filament winding method, hand lay-up method, RTM forming method and the like. Among them, the filament winding method, the RTM forming method, and the pultrusion method and pull-wind forming method in which methods fiber bundles comprising carbon fibers are integrally molded while impregnating the bundles with a resin, are economical methods. On the other hand, the hand lay-up method is suitable for small-scale production or production of FRP members having complicated and specific structure.

(Use)

The FRP structural member of this invention is used for members for general structures, buildings and the like. The FRP member for general structures can be used as aggregates, frame materials, beams, columns, support legs, rails and guides for various structures.

Furthermore, the members for buildings include not only members for residential buildings such as wooden buildings, steel-frame buildings, cement mortal buildings, brick buildings and the like, but also members that can be used for various buildings such as large buildings having reinforced concrete structure, high-rise buildings, factories such as chemical factories and the like, warehouses, car sheds, agricultural vinyl plastic hothouses, horticultural houses, solar houses, pedestrian bridges, public telephone boxes, mobile and simple toilet rooms, shower rooms, garages, terraces, benches, guard rails, advertising towers, huts, huts for pets, tent huts, storerooms, small and simple buildings such as prefabricated buildings and the like. Examples of use of the members are reinforced materials for water storage tanks on the roof of buildings, duct reinforcing materials, pool materials, frames for doors and windows, sashes for eaves, beams for ceilings and floors, thresholds, partition materials, side wall materials, head jambs, columns, sashes for partitioning rooms, rain gutters, scaffolds and the like.

### EXAMPLES

### Example 1

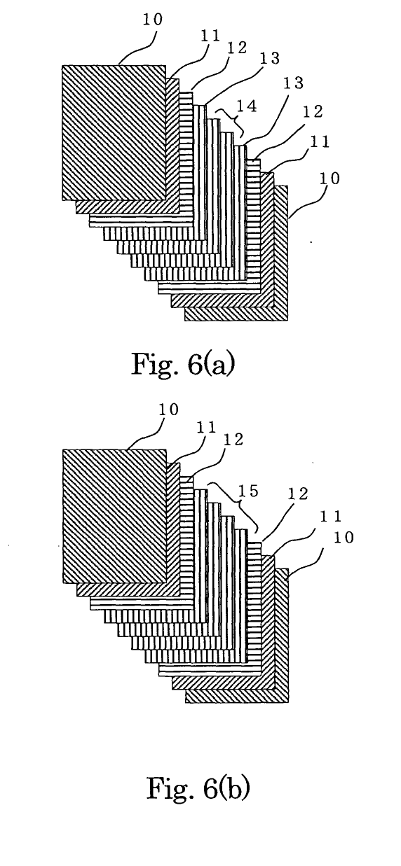

Reinforcing fibers were aligned in one direction, and then were impregnated with an epoxy resin to give a unidirectional prepreg. A unidirectional prepreg comprising carbon fibers was prepared in the same manner as the above unidirectional prepreg. The unidirectional prepreg comprising reinforcing fibers and the unidirectional prepreg comprising carbon fibers were laminated to form an FRP I-shaped beam having an I-shaped cross-section. The laminate construction of the FRP I-shaped beam was, as shown in FIG. 6, ten-plies structure of [+45/−45/90/0/0/0/0/90/−45/+45]=[+45/−45/90/0/0]s for flanges and a web, and the thickness of the member was 5 mm consisting of ten plies wherein each ply had the thickness of 0.5 mm. The numerals “+45”, “90” and the like mean the orientation angle of the fibers relative to the longitudinal direction of the beam.

Glass fibers were used as reinforcing fibers, and T700S (manufactured by Toray Industries, Inc., tensile modulus: 230 GPa) and XN-80 (manufactured by Nippon Graphite Fiber Corp., tensile modulus: 780 GPa) were used as the two kinds of carbon fibers, respectively. As shown in FIG. 6, the unidirectional prepreg comprising the carbon fibers T700S was used in 0 degree-layers that consist of two-plies in the flanges, and the unidirectional prepreg comprising the carbon fiber XN-80 was used in residual 0 degree-layers that consist of two-plies in the flanges, and the unidirectional prepreg comprising the glass fibers was used in the other layers, i.e., +45 degrees-layers of the flanges, −45 degrees-layers of the flanges, 90 degrees-layers of the flanges and the whole layers of the web. The I-shaped beam was formed by hand lay-up method. The volumetric content of the reinforcing fibers and carbon fibers was 50 vol %.

FIG. 6(a) shows the laminate structure of the flange, and FIG. 6(b) shows the laminate structure of the web, respectively. In FIG. 6, number 10 denotes a glass fiber unidirectional prepreg in which the fibers are oriented at an angle of +45 degrees relative to the longitudinal direction of the beam, number 11 a glass fiber unidirectional prepreg in which the fibers are oriented at an angle of −45 degrees relative to the longitudinal direction of the beam, number 12 a glass fiber unidirectional prepreg in which the fibers are oriented at an angle of 90 degrees relative to the longitudinal direction of the beam, number 13 a carbon fiber T700S unidirectional prepreg in which the fibers are oriented at an angle of 0 degree relative to the longitudinal direction of the beam, number 14 a carbon fiber XN-80 unidirectional prepreg in which the fibers are oriented at an angle of 0 degree relative to the longitudinal direction of the beam, and number 15 a glass fiber unidirectional prepreg in which the fibers are oriented at an angle of 0 degree relative to the longitudinal direction of the beam, respectively. In the other drawings, the same number means the same component.

The FRP I-shaped beam was measured for the deflections by deadweight and by uniformly distributed load, respectively. The beam had flange width of 100 mm, beam (member) height of 100 mm and length of 2000 mm, in which the flanges and the web were each 5 mm in thickness. The web height was 90 mm (=beam height−flange thickness×2).

As shown in Table 1, the FRP I-shaped beam of Example 1 had light weight and low deflection by deadweight, and had high bending rigidity and low bending deflection. Furthermore, the FRP I-shaped beam was measured for the vibration-damping property according to the following procedures.

A modal hammer MODEL2302-5 (trade name, manufactured by Endevco, Corp.) was connected to an FFT analyzer TYPE 2035 (trade name, manufactured by Bruel & Kjaer Inc.). The I-shaped beam was vertically hanged with a wire that attached to one end of the beam, and was given an impact with the modal hammer. The thus-caused vibration was measured by an acceleration pickup TYPE4374 that attached to the lower end (free end) of the I-shaped beam. Then, the relation between the input signal by the hammer and the acceleration signal by the acceleration pickup was analyzed by FFT (fast Fourier transform) analysis and the beam was evaluated for the vibration-damping property.

The FRP I-shaped beam of Example 1 had superior vibration-damping property.

### Example 2

A unidirectional prepreg comprising reinforcing fibers and a unidirectional prepreg comprising carbon fibers were laminated to form an FRP I-shaped beam having an I-shaped cross-section. The laminate construction of the FRP I-shaped beam was, as shown in FIG. 6, ten-plies structure of [+45/−45/90/0/0/0/0/90/−45/+45]=[+45/−45/90/0/0]s for flanges and a web, and the thickness of the member was 2 mm consisting of ten-plies wherein each ply had the thickness of 0.2 mm. Glass fibers were used as the reinforcing fibers, and T700S (manufactured by Toray Industries, Inc., tensile modulus: 230 GPa) and XN-80 (manufactured by Nippon Graphite Fiber Corp., tensile modulus: 780 GPa) were used as the two kinds of carbon fibers, respectively. In the same way as Example 1, and as shown in FIG. 6, the unidirectional prepreg comprising the carbon fibers T700S was used in 0 degree-layers that consist of two-plies in the flanges, and the unidirectional prepreg comprising the carbon fibers XN-80 was used in residual 0 degree-layers that consist of two-plies in the flanges, and the unidirectional prepreg comprising the glass fibers was used in the other layers, i.e., +45 degrees-layers of the flanges, −45 degrees-layers of the flanges, 90 degrees-layers of the flanges and the whole layers of the web. The I-shaped beam was formed by hand lay-up method, and an epoxy resin was used as a matrix resin. The volumetric content of the reinforcing fibers and carbon fibers was 50 vol %.

The FRP I-shaped beam was measured for the deflections by deadweight and by uniformly distributed load, respectively. The beam had flange width of 100 mm, beam (member) height of 100 mm and length of 2000 mm, in which the flanges and the web were each 2 mm in thickness. The web height was 96 mm (=beam height−flange thickness×2).

As shown in Table 1, the FRP I-shaped beam of Example 2 had light weight and low deflection by deadweight, and had high bending rigidity and low bending deflection. Furthermore, the FRP I-shaped beam of Example 2 was evaluated for the vibration-damping property in the same manner as Example 1 to show that the FRP I-shaped beam of Example 2 had superior vibration-damping property.

### Example 3

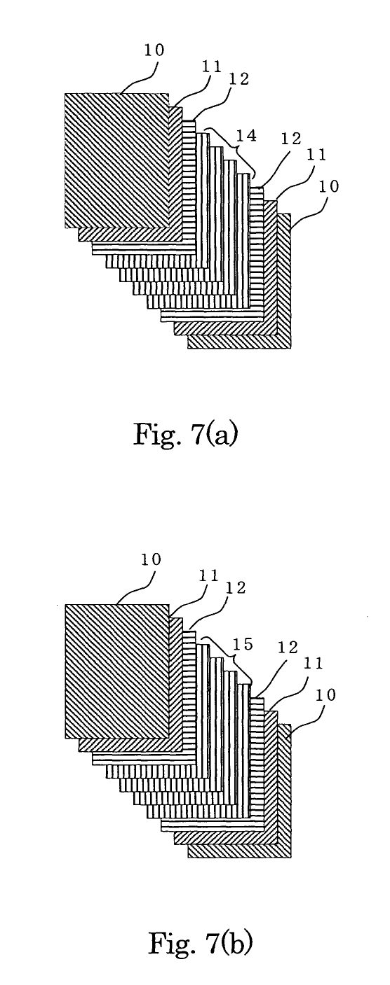

A unidirectional prepreg comprising reinforcing fibers and a unidirectional prepreg comprising carbon fibers were laminated to form an FRP I-shaped beam having an I-shaped cross-section. The size of the FRP I-shaped beam was the same as that of Example 1. Glass fibers were used as reinforcing fibers, and XN-80 (manufactured by Nippon Graphite Fiber Corp., tensile modulus: 780 GPa) was used as the carbon fiber, respectively. As shown in FIG. 7, the unidirectional prepreg comprising the carbon fibers XN-80 (manufactured by Nippon Graphite Fiber Corp., tensile modulus: 780 GPa) was used only in 0 degree-layers in the flanges, and the unidirectional prepreg comprising the glass fibers was used in the other layers, i.e., +45 degrees-layers of the flanges, −45 degrees-layers of the flanges, 90 degrees-layers of the flanges and the whole layers of the web. The I-shaped beam was formed by hand lay-up method and an epoxy resin was used as a matrix resin. The volumetric content of the reinforcing fibers and carbon fibers was 50 vol %. FIG. 7(a) shows the laminate structure of the flange, and FIG. 7(b) shows the laminate structure of the web, respectively.

As shown in Table 1, the FRP I-shaped beam of Example 3 had light weight and low deflection by deadweight, and had high bending rigidity and low bending deflection. Furthermore, the FRP I-shaped beam of Example 3 was evaluated for the vibration-damping property in the same manner as Example 1 to show that the FRP I-shaped beam of Example 3 had superior vibration-damping property.

### Example 4

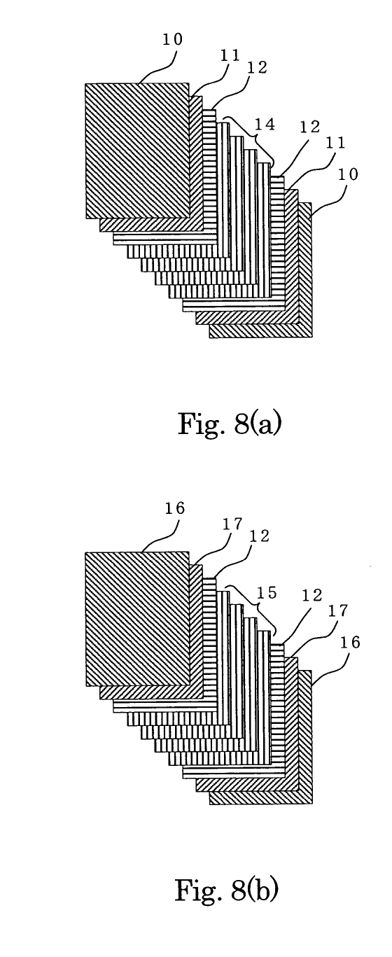

A unidirectional prepreg comprising reinforcing fibers and a unidirectional prepreg comprising carbon fibers were laminated to form an FRP I-shaped beam having an I-shaped cross-section. The size of the FRP I-shaped beam was the same as that of Example 1. Glass fibers were used as reinforcing fibers, and XN-80 (manufactured by Nippon Graphite Fiber Corp., tensile modulus: 780 GPa) was used as the carbon fiber, respectively. As shown in FIG. 8, the unidirectional prepreg comprising the carbon fibers XN-80 (manufactured by Nippon Graphite Fiber Corp., tensile modulus: 780 GPa) was used in 0 degree-layers in the flanges, and in +45 degrees-layers of the web and −45 degrees-layers of the web, and the unidirectional prepreg comprising glass fibers was used in the other layers, i.e., +45 degrees-layers of the flanges, −45 degrees-layers of the flanges, 90 degrees-layers of the flanges, 0 degree-layers of the web and 90 degrees-layers of the web. The I-shaped beam was formed by hand lay-up method, and an epoxy resin was used as a matrix resin. The volumetric content of the reinforcing fibers and carbon fibers was 50 vol %.

FIG. 8(a) shows the laminate structure of the flange, and FIG. 8(b) shows the laminate structure of the web, respectively. In FIG. 8, number 16 denotes a carbon fiber XN-80 unidirectional prepreg in which the fibers are oriented at an angle of +45 degrees relative to the longitudinal direction of the beam and number 17 a carbon fiber XN-80 unidirectional prepreg in which the fibers are oriented at an angle of −45 degrees relative to the longitudinal direction of the beam, respectively.

As shown in Table 1, the FRP I-shaped beam of Example 4 had high bending rigidity and low bending deflection. Furthermore, the FRP I-shaped beam of Example 4 was evaluated for the vibration-damping property in the same manner as Example 1 to show that the FRP I-shaped beam of Example 4 had superior vibration-damping property.

### Example 5

An FRP I-shaped beam having an I-shaped cross-section was formed from a unidirectional prepreg comprising glass fibers, and two unidirectional prepregs respectively comprising carbon fibers, i.e., T700S (manufactured by Toray Industries, Inc., tensile modulus: 230 GPa) and XN-80 (manufactured by Nippon Graphite Fiber Corp., tensile modulus: 780 GPa). An epoxy resin was used as a matrix resin. The laminate construction of the FRP I-shaped beam was ten-plies structure of [+45/−45/90/0/0/0/0/90/−45/+45] for flanges and a web.

The following six kinds of FRP I-shaped beams were prepared according to this invention in order to compare them with a steel beam and a conventional FRP I-shaped beam comprising only glass fibers in weight and costs.

(All-T700S Beam)

An FRP I-shaped beam having the flange width of 300 mm, flange thickness of 35 mm, I-shaped beam total height of 600 mm and web thickness of 20 mm was formed using a unidirectional carbon fiber prepreg comprising T700S (manufactured by Toray Industries, Inc., tensile modulus: 230 GPa) according to said laminate structure. The length of the beam was 10 m, and the beam was formed by hand lay-up method. The weight of the FRP I-shaped beam obtained was 4500 N, and the deflection in 980 N/m uniformly distributed load test method was 2.0 mm (inclusive of deflection by deadweight), and the bending rigidity of the FRP I-shaped beam measured by this method was 9.31×10⁷ N·m². This FRP I-shaped beam was comparatively light in weight, but was high in cost.

(All-XN-80 Beam)

An FRP I-shaped beam having the flange width of 300 mm, flange thickness of 10 mm, I-shaped beam total height of 600 mm and web thickness of 7 mm was formed using a unidirectional carbon fiber prepreg comprising XN-80 (manufactured by Nippon Graphite Fiber Corp., tensile modulus: 780 GPa) according to said laminate structure. The length of the beam was 10 m, and the beam was formed by hand lay-up method. The weight of the FRP I-shaped beam obtained was 1520 N, and the deflection in 980 N/m uniformly distributed load test method was 1.58 mm (inclusive of deflection by deadweight), and the bending rigidity of the FRP I-shaped beam measured by this method was 9.32×10⁷ N·m². This FRP I-shaped beam was light in weight, but was high in cost.

(T700S/GF Hybrid Beam)

An FRP I-shaped beam having the flange width of 300 mm, flange thickness of 42 mm, I-shaped beam total height of 600 mm and web thickness of 28 mm was formed using a unidirectional carbon fiber prepreg comprising T700S (manufactured by Toray Industries, Inc., tensile modulus: 230 GPa) and a unidirectional glass fiber prepreg comprising glass fibers according to said laminate structure. The unidirectional carbon fiber prepreg comprising T700S was used only in the longitudinal direction (0 degree) in the flanges, and the unidirectional glass fiber prepreg was used in the other sites, i.e., +45 degrees-layers of the flanges, −45 degrees-layers of the flanges, 90 degrees-layers of the flanges and the whole layers of the web. The length of the beam was 10 m, and the beam was formed by hand lay-up method. The weight of the FRP I-shaped beam obtained was 6460 N, and the deflection in 980 N/m uniformly distributed load test method was 2.27 mm (inclusive of deflection by deadweight), and the bending rigidity of the FRP I-shaped beam measured by this method was 9.32×10⁷ N·m². This FRP I-shaped beam was comparatively low in cost, but was heavy in weight.

(XN-80/GF Hybrid Beam)

An FRP I-shaped beam having the flange width of 300 mm, flange thickness of 13 mm, I-shaped beam total height of 600 mm and web thickness of 9 mm was formed using a unidirectional carbon fiber prepreg comprising XN-80 (manufactured by Nippon Graphite Fiber Corp., tensile modulus: 780 GPa) and a unidirectional glass fiber prepreg comprising glass fibers according to said laminate structure. The unidirectional carbon fiber prepreg comprising XN-80 was used only in the longitudinal direction (0 degree) in the flanges, and the unidirectional glass fiber prepreg was used in the other sites, i.e., +45 degrees-layers of the flanges, −45 degrees-layers of the flanges, 90 degrees-layers of the flanges and the whole layers of the web. The length of the beam was 10 m, and the beam was formed by hand lay-up method. The weight of the FRP I-shaped beam obtained was 2180 N, and the deflection in 980 N/m uniformly distributed load test method was 1.68 mm (inclusive of deflection by deadweight), and the bending rigidity of the FRP I-shaped beam measured by this method was 9.31×10⁷ N·m². This FRP I-shaped beam was light in weight and low in cost.

(T700S/XN-80/GF Hybrid Beam)

An FRP I-shaped beam having the flange width of 300 mm, flange thickness of 13 mm, I-shaped beam total height of 600 mm and web thickness of 9 mm was formed using a unidirectional carbon fiber prepreg comprising T700S (manufactured by Toray Industries, Inc., tensile modulus: 230 GPa), or XN-80 (manufactured by Nippon Graphite Fiber Corp., tensile modulus: 780 GPa) and a unidirectional glass fiber prepreg comprising glass fibers according to said laminate structure. The unidirectional carbon fiber prepreg comprising the T700S was used in two-plies of the flanges in the longitudinal direction (0 degree), the unidirectional carbon fiber prepreg comprising the XN-80 was used in residual two-plies of the flanges in the longitudinal direction (0 degree), and the unidirectional glass fiber prepreg was used in the other layers, i.e., +45 degrees-layers of the flanges, −45 degrees-layers of the flanges, 90 degrees-layers of the flanges and the whole layers of the web. The length of the beam was 10 m, and the beam was formed by hand lay-up method. The weight of the FRP I-shaped beam obtained was 3225 N, and the deflection in 980 N/m uniformly distributed load test method was 1.82 mm (inclusive of deflection by deadweight), and the bending rigidity of the FRP I-shaped beam measured by this method was 9.31×10⁷ N·m². This FRP I-shaped beam was light in weight and low in cost.

The following two beams were formed according to the conventional method in order to compare them with the FRP I-shaped beam of this invention.

(All-GFRP Beam)

An FRP I-shaped beam having the flange width of 300 mm, flange thickness of 80 mm, I-shaped beam total height of 700 mm and web thickness of 25 mm was formed using a unidirectional glass fiber prepreg comprising glass fibers according to said laminate structure. The obtained All-GFRP beam is a conventional FRP I-shaped beam using only glass fibers as reinforcing fibers. The length of the beam was 10 m, and the beam was formed by hand lay-up method. The weight of the FRP I-shaped beam obtained was 10540 N, and the deflection in 980 N/m uniformly distributed load test method was 2.81 mm (inclusive of deflection by deadweight), and the bending rigidity of the FRP I-shaped beam measured by this method was 9.44×10⁷ N·m². This FRP I-shaped beam was heavier in weight and higher in cost than a steel beam.

(Steel Beam)

A steel beam having the flange width of 300 mm, flange thickness of 10 mm, I-shaped beam total height of 500 mm and web thickness of 10 mm was formed. The weight of the steel beam obtained was 8250 N, and the deflection in 980 N/m uniformly distributed load test method was 2.53 mm (inclusive of deflection by deadweight), and the bending rigidity of the I-shaped beam measured by this method was 9.32×10⁷ N·m². This steel beam had cost similar to or lower than that of said FRP I-shaped beams of this invention, but was extremely adverse in view of its heavy weight.

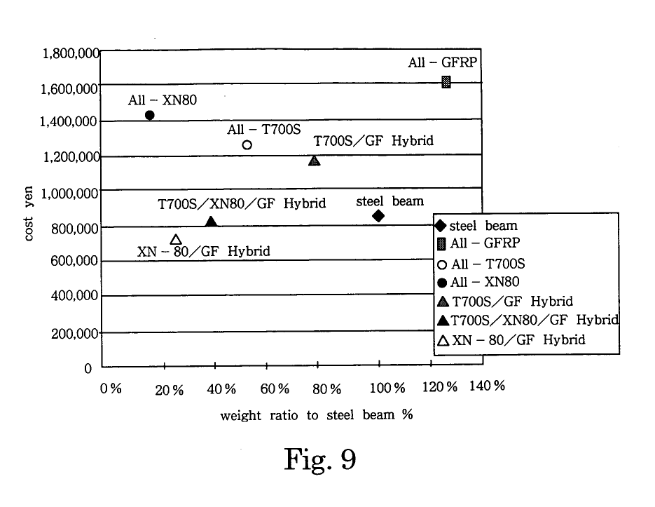

As shown in FIG. 9, taking notice of the relation in the cost and in weight to the steel beam, all the All-T700S beam, All-XN80 beam, T700S/GF Hybrid beam, XN-80/GF Hybrid beam, T700S/XN-80/GF Hybrid beam were lighter than the conventional All-GFRP beam and the steel beam. Furthermore, XN-80/GF Hybrid beam and T700S/XN-80/GF Hybrid beam of this invention could be formed at smaller cost than All-GFRP beam, All-XN80 beam and T700S/GF Hybrid beam.

### Comparative Example 1

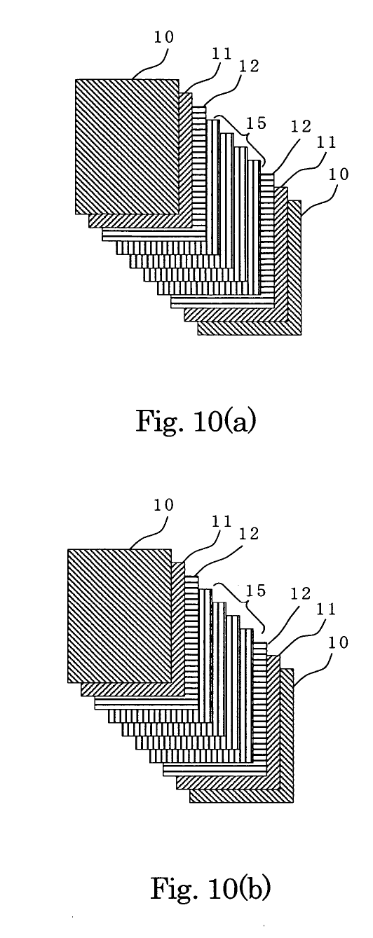

An FRP I-shaped beam having an I-shaped cross-section was formed by laminating a unidirectional prepreg comprising reinforcing fibers. The size of the FRP I-shaped beam was the same as that of Example 1. Glass fibers were used as reinforcing fibers. As shown in FIG. 10, a unidirectional prepreg comprising glass fibers was used in all sites of the I-shaped beam. The I-shaped beam was formed by hand lay-up method, and an epoxy resin was used as a matrix resin. The volumetric content of the reinforcing fibers was 50 vol %. FIG. 10(a) shows the laminate structure of the flange, and FIG. 10(b) shows the laminate structure of the web, respectively.

As shown in Table 1, since the I-shaped beam of Comparative Example 1 had heavy weight and low bending rigidity, large deflection was produced by deadweight and by uniformly distributed load. Furthermore, said FRP I-shaped beam of Comparative Example 1 was evaluated for the vibration-damping property in the same manner as Example 1 to show that the FRP I-shaped beam of Comparative Example 1 had poorer vibration-damping property than the FRP I-shaped beams of Examples.

### Comparative Example 2

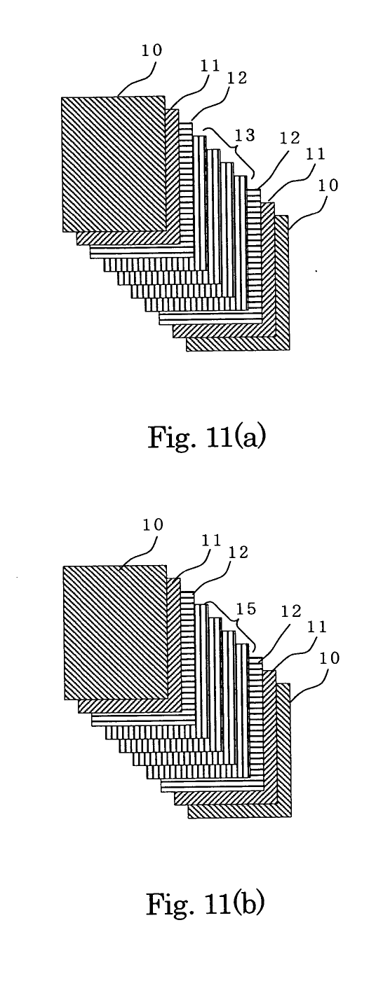

An FRP I-shaped beam having an I-shaped cross-section was formed by laminating a unidirectional prepreg comprising reinforcing fibers and a unidirectional prepreg comprising carbon fibers. The laminate construction of the FRP I-shaped beam was ten-plies structure of [+45/−45/90/0/0/0/0/90/−45/+45]=[+45/−45/90/0/0]s for flanges and a web, and the thickness of the member was 12 mm consisting of ten-plies wherein each ply had the thickness of 1.2 mm. Glass fibers were used as reinforcing fibers, and T700S (manufactured by Toray Industries, Inc., tensile modulus: 230 GPa) was used as a carbon fiber, respectively. As shown in FIG. 11, the unidirectional prepreg comprising the carbon fibers T700S was used only in 0 degree-layers in the flanges, and the unidirectional prepreg comprising the glass fibers was used in the other layers, i.e., +45 degrees-layers of the flanges, −45 degrees-layers of the flanges, 90 degrees-layers of the flanges and the whole layers of the web. The I-shaped beam was formed by hand lay-up method, and an epoxy resin was used as a matrix resin. The volumetric content of the reinforcing fibers and carbon fibers was 50 vol %. FIG. 11(a) shows the laminate structure of the flange, and FIG. 11(b) shows the laminate structure of the web, respectively.

The I-shaped beam had flange width of 100 mm, beam height of 100 mm and length of 2000 mm, in which the flanges and the web were each 12 mm in thickness. The web height was 76 mm (=beam height−flange thickness×2).

As shown in Table 1, the FRP I-shaped beam of Comparative Example 2 had similar total deflection to that of the FRP I-shaped beam of Example 1, but was very heavy and comprised large amounts of reinforcing fibers and of resins required for forming. Furthermore, the FRP I-shaped beam of Comparative Example 2 was evaluated for the vibration-damping property in the same manner as Example 1 to show that the FRP I-shaped beam of Comparative Example 2 had poorer vibration-damping property than the FRP I-shaped beams of Examples.

### Comparative Example 3

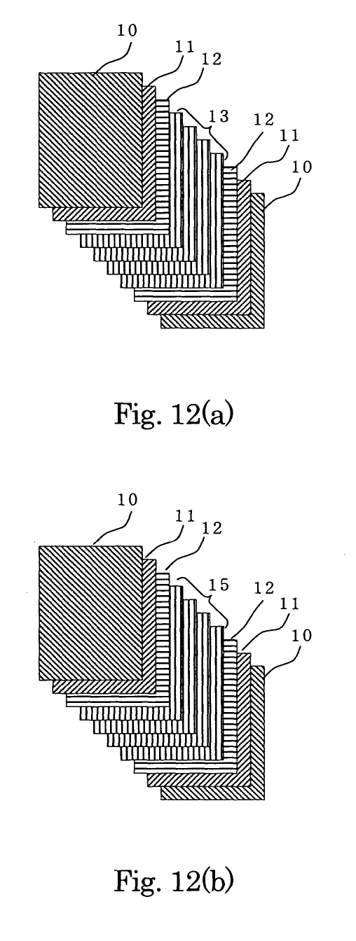

An FRP I-shaped beam having an I-shaped cross-section was formed by laminating a unidirectional prepreg comprising reinforcing fibers and a unidirectional prepreg comprising carbon fibers. The laminate construction of the FRP I-shaped beam was ten-plies structure of [+45/−45/90/0/0/0/0/90/−45/+45]=[+45/−45/90/0/0]s for flanges and a web, and the thickness of the member was 2 mm consisting of ten-plies wherein each ply had the thickness of 0.2 mm. Glass fibers were used as reinforcing fibers, and T700S (manufactured by Toray Industries, Inc., tensile modulus: 230 GPa) was used as a carbon fiber, respectively. As shown in FIG. 12, the unidirectional prepreg comprising the carbon fibers T700S was used only in 0 degree-layers in the flanges, and the unidirectional prepreg comprising the glass fibers was used in all the other layers, i.e., +45 degrees-layers of the flanges, −45 degrees-layers of the flanges, 90 degrees-layers of the flanges and the whole layers of the web. The I-shaped beam was formed by hand lay-up method, and an epoxy resin was used as a matrix resin. The volumetric content of the reinforcing fibers and carbon fibers was 50 vol %. FIG. 12(a) shows the laminate structure of the flange, and FIG. 12(b) shows the laminate structure of the web, respectively.

The I-shaped beam had flange width of 100 mm, beam height of 100 mm and length of 2000 mm, in which the flange and web were each 2 mm in thickness. The web height was 96 mm (=beam height−flange thickness×2).

As shown in Table 1, the FRP I-shaped beam of Comparative Example 3 had similar weight to that of the FRP I-shaped beam of Example 2, but had low bending rigidity, so the beam of Comparative Example 3 had very large deflection occurred by deadweight and by uniformly distributed load. Furthermore, the FRP I-shaped beam of Comparative Example 3 was evaluated for the vibration-damping property in the same manner as Example 1 to show that the FRP I-shaped beam of Comparative Example 3 had poorer vibration-damping property than the FRP I-shaped beams of Examples.

The characteristics of the I-shaped beams of Examples 1 to 4 and Comparative Examples 1 to 3 are collectively shown in Table 1.

TABLE 1

| | | | | | Comp. | Comp. | Comp. |
|---|---|---|---|---|---|---|---|
| | Ex.1 | Ex.2 | Ex.3 | Ex.4 | Ex.1 | Ex.2 | Ex.3 |
| Size of member | | | | | | | |
| Width of flange mm | 100 | 100 | 100 | 100 | 100 | 100 | 100 |
| Height of member mm | 100 | 100 | 100 | 100 | 100 | 100 | 100 |
| Thickness of member mm | 5 | 2 | 5 | 5 | 5 | 12 | 2 |
| Fibers | | | | | | | |
| Flange (0) | XN-80 | XN-80 | XN-80 | XN-80 | GF | T700S | T700S |
| | T700S | T700S | | | | | |
| (±45/90) | GF | GF | GF | GF | GF | GF | GF |
| Web (±) | GF | GF | GF | XN-80 | GF | GF | GF |
| (0/90) | GF | GF | GF | GF | GF | GF | GF |
| Length of beam mm | 2000 | 2000 | 2000 | 2000 | 2000 | 2000 | 2000 |
| Weight of beam N | 50.9 | 20.5 | 52.0 | 50.9 | 53.9 | 114.6 | 20.6 |
| Deflection by deadweight mm | 0.02 | 0.03 | 0.01 | 0.01 | 0.10 | 0.05 | 0.04 |
| Deflection by 980 N/m uniformly | 0.81 | 1.89 | 0.54 | 0.50 | 3.56 | 0.78 | 3.71 |
| distributed load mm | ________ | | | | | | |
| Total deflection mm | 0.83 | 1.92 | 0.55 | 0.51 | 3.66 | 0.83 | 3.75 |
| Bending rigidity | 2.53 × 10⁵ | 1.08 × 10⁵ | 3.77 × 10⁵ | 3.80 × 10⁵ | 5.74 × 10⁴ | 2.60 × 10⁵ | 5.50 × 10⁴ |
| N · m² | | | | | | | |
| Vibration-damping property | High | High | High | High | Low | Low | Low |

As explained above, this invention can provide an FRP structural member, which has high vibration-damping property and much lower production cost than those of conventional products as well as light weight, high rigidity and superior corrosion property. According to the provisional estimation, the production cost for the FRP structural member of this invention is similar to or lower than those for steel structural members.

What is claimed is:

1. An FRP structural member comprising reinforcing fibers, which comprises carbon fibers (a) having tensile modulus of 400 to 850 GPa, in which the carbon fibers (a) are placed so that the orientation direction of the carbon fibers (a) becomes parallel to the longitudinal direction of the structural member.

2. The FRP structural member according to claim 1, which further comprises carbon fibers (b) having tensile modulus of 200 to less than 400 GPa, in which the carbon fibers (b) are placed so that the orientation direction of the carbon fibers (b) becomes parallel to the longitudinal direction of the structural member.

3. The FRP structural member according to claim 1, wherein the carbon fibers (a) are placed in the range of not more than 50% of the distance between the surface of the member and a neutral surface in the cross-section surface of the member and in the direction of the neutral surface from the surface of the member.

4. The FRP structural member according to claim 2, wherein the carbon fibers (b) are placed in the range of not more than 50% of the distance between the surface of the member and a neutral surface in the cross-section surface of the member and in the direction of the neutral surface from the surface of the member.

5. The FRP structural member according to claim 1, which further comprises carbon fibers (c) having tensile modulus of 200 to 850 GPa, in which the carbon fibers (c) are placed in the site vertical to the neutral surface in the cross-sectional surface of the member and wherein the orientation direction of the carbon fibers (c) forms an angle of ±45 degrees relative to the longitudinal direction of the member.

6. The FRP structural member according to claim 2, which further comprises carbon fibers (c) having tensile modulus of 200 to 850 GPa, in which the carbon fibers (c) are placed in the site vertical to the neutral surface in the cross-sectional surface of the member and wherein the orientation direction of the carbon fibers (c) forms an angle of ±45 degrees relative to the longitudinal direction of the member.

7. The FRP structural member according to claim 6, wherein a total amount of the carbon fibers (a), the carbon fibers (b) and the carbon fibers (c) used is 5 to 25% by mass, based on a total amount of the reinforcing fibers and carbon fibers used in the FRP structural member.
